(19) United States
(12) Patent Application Publication
(10) Pub. No.: US 2017/0293876 A1
(43) Pub. Date: Oct. 12, 2017

(54) METHOD AND SYSTEM FOR MANAGING GRANTS

(71) Applicant: StreamLink Software Inc., Cleveland, OH (US)

(72) Inventor: Adam Roth, Shaker Heights, OH (US)

(21) Appl. No.: 15/355,894

(22) Filed: Nov. 18, 2016

Related U.S. Application Data
(63) Continuation of application No. 13/832,402, filed on Mar. 15, 2013, now abandoned.
(60) Provisional application No. 61/707,032, filed on Sep. 28, 2012.

(51) Int. Cl. G06Q 10/06

(52) U.S. Cl. CPC G06Q 10/06393; G06Q 10/0639; G06Q 10/06

(57) ABSTRACT

A system and method for managing grants is provided. A method includes multiple entities associated with a grant, each having an instance of a grant management application. Each instance of the grant management application includes the capability to receive disparate fiscal, human resource, and program data associated with the grant, and to compare the combined data to a goal of the grant to determine the entity's performance to the goal. The combination of instances of the grant management application allows for a complete roll-up of individual entity's performance into a total performance for the funder of the grant and according to the funder's specifications.

### CROSS REFERENCE TO RELATED APPLICATIONS

This application is a continuation of U.S. patent application Ser. No. 13/832,402, filed Mar. 15, 2013, titled METHOD AND SYSTEM FOR MANAGING GRANTS (Attorney Docket No. 35222/04002), which claims priority to U.S. provisional patent application Ser. No. 61/707,032, filed Sep. 28, 2012, titled METHOD AND SYSTEM FOR MANAGING GRANTS (Attorney Docket No. 35222/04001). The contents of all above-identified patent applications are fully incorporated herein by reference.

### BACKGROUND

A grant may represent or include an award, transfer, or distribution of resources, such as funds or money, to enable, promote, or encourage some activity, result, or outcome. A grant may be assigned from a grantor to one entity, who then may assign all of a portion of the grant to one or more other entities, including various obligations or assignments and performance expectations. These other entities may also delegate portions of the grant to other entities. Changing grantor requirements, communication inefficiencies between entities, increased complexity, and incompatible tracking and/or reporting systems are typical characteristics associated with the grant environment.

### SUMMARY

In one embodiment, a method for managing grants, including at least one instance of a grant management application, wherein the at least one instance of the grant management application includes receiving at least two of fiscal data associated with at least one grant, human resource data associated with the at least one grant, and program data associated with the at least one grant, comparing at least one of the fiscal data, the human resource data, and the program data to at least one goal of the at least one grant, determining performance associated with the at least one goal, and reporting the performance.

The descriptions of the invention do not limit the words used in the claims in any way or the scope of the claims or invention. The words used in the claims have all of their full ordinary meanings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of this invention.

FIG. 1 is a chart showing exemplary activities associated with an exemplary grant life cycle;

FIG. 2 illustrates an exemplary grant ecosystem and data sources;

FIG. 3 illustrates another exemplary grant ecosystem highlighting exemplary data types;

FIG. 4 illustrates another exemplary grant ecosystem showing exemplary relationships between entities;

FIG. 5 illustrates another exemplary grant ecosystem showing exemplary relationships between entities;

FIG. 6 is a flowchart showing exemplary steps associated with an exemplary process associated with data from multiple sources;

FIG. 7 is a flowchart showing exemplary steps associated with an exemplary process associated with programmatic data;

FIG. 8 illustrates another exemplary grant ecosystem showing exemplary relationships between entities; and

FIG. 9 illustrates exemplary communication protocols and exemplary devices associated with a grant management application.

### DESCRIPTION

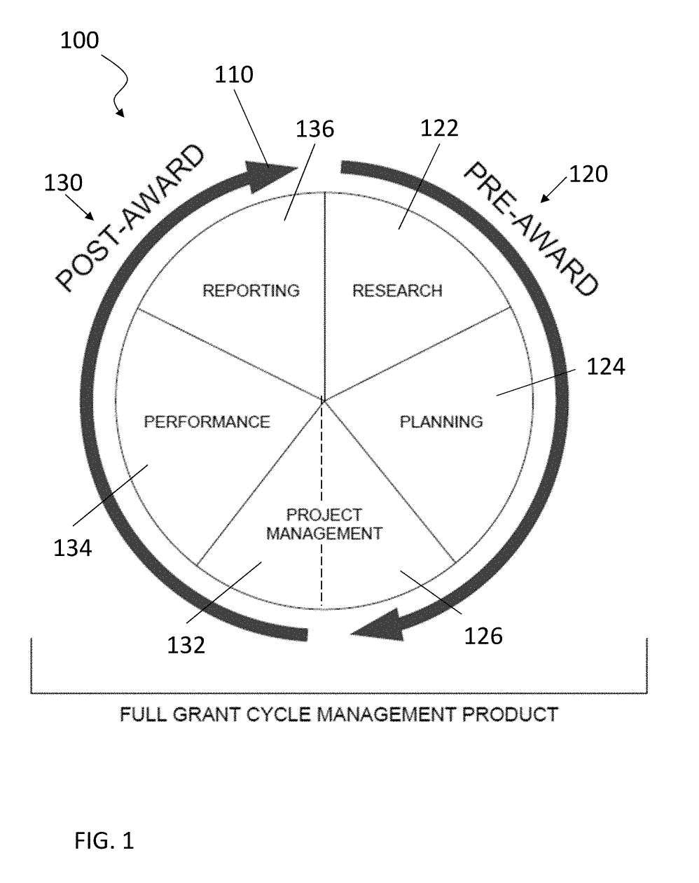

As shown in FIG. 1, an exemplary fund and/or grant management application or program 100 can allow entities, such as organizations, to manage a fund and/or a full grant lifecycle 110, including pre-award activities 120 and post-award activities 130 for their entire grant portfolios. A fund may include one or more associated grants. The application 100 may include other applications associated with the application 100, for example, sub-applications to handle certain tasks.

In one embodiment, StreamLink's® AmpliFund Full Cycle (FC) is an exemplary fund and grant management application 100 that can allow, for example, funders, grantors, and grantees, which may be, for example, nonprofit and public sector institutions, to manage the complex process of a grant life cycle 110. The application 100 can support the full grant environment, which may include various entities and relationships, or a grant “ecosystem,” which may include, for example, one institution managing one grant or in the case of a large municipality, it could represent 100+ institutions managing 1,000+ grants. In another embodiment, the application 100 can be used by a funder to manage a fund, as discussed in more detail below. The application 100 can create a flexible and expandable grant ecosystem which can provide each entity, such as an organization or an institution, in the ecosystem their own instance of the application 100. This can allow them to manage their specific funding responsibilities/requirements but can also link their performance to others in the ecosystem, including linking or communicating with other instances of the application 100, with the goal of consolidating data from countless end points, for example, recipients, and producing a standard grant data set for a specific funder or funders.

Referring back to FIG. 1, the full grant life cycle 130 may include, for example, research 122, planning 124, project management 126, 132, performance 134, and reporting 136 activities, among others. In other embodiments, all activities may not be included in the full grant life cycle 130.

For example, even before a grant is awarded, organizations may be involved with several activities, such as, for example, research 122, planning 124, and project management 126. Regarding research 122, for example, the application 100 can integrate research data from potential funders on funding opportunities into the application 100 from a variety of third party research tools. In another embodiment, the application 100 can also create a grant constituent relationship database. Regarding planning 124, for example, the application 100 can identify which funding opportunities represent the greatest likelihood of success and plan a communication strategy to pursue those opportunities. In addition, funders may use the application 100 to identify potential grantees with the largest likelihood of success in completing a particular grant's goals. In other embodiments, the application 100 may include providing users with business intelligence to quickly link opportunities with timelines and probabilities of success. In addition, the application 100 may integrate actual results with budgets to create current projections that can support organizational planning. Regarding pre-award project management 126, for example, the application 100 can manage timelines, due dates, and follow-up communications for the grant planning and submission process.

In one embodiment, funders may elect to provide a request for proposal or other funding cycle information to potential recipients via the application 100. These grant opportunities may be applied for by other users of the application 100, who may be potential lead or sub-recipients of the grant. In another embodiment, funders may also manage a fund within the application 100, including, for example, creating grants from a fund, which may then be allocated to recipients. These processes, which may include specific reporting requirements, may be driven by the funder within the ecosystem.

After a grant is awarded, organizations may be involved with several other activities, such as, for example, additional post-award project management 132, performance 134, and reporting 136. Regarding project management 132, for example, the application 100 can manage timelines, due dates, performance reporting, budget allocations, and follow-up communications for the post-award segment 130 of the grant cycle 110. Regarding performance 134, for example, the application 100 allows organizations to track both fiscal performance and programmatic performance. For example, regarding financial performance, the application 100 can work with financial data from any accounting system to provide an overview of projected and actual revenue and expenditures. For example, regarding programmatic performance, the application 100 can facilitate the assignment of tasks related to grant goals to make sure programs stay on course to meet their objectives. Regarding reporting 136, for example, the application 100 can consolidate data from across the organization into a standard data set for each grant. This may include integrating performance and budget tracking, which can be formatted into custom reports driven by funder requirements or rolled up to the funder and made accessible via an application 100 module, such as, for example, a fund module. These processes may also simplify the organizational and grant audit process.

When describing the grant relationships within a grant ecosystem (such as those described below in exemplary ecosystems 200, 300, 400, 500), several terms may be utilized. “Funder(s)”—They are the entities funding one or more grants through the distribution of funds to one or more lead recipients. The funder defines the data standards and types of information that the funder wants to receive from and/or into an application 100. Funders may also utilize the application 100 to create and manage funds, allocate grants to lead recipients out of funds, and receive rolled-up data regarding allocated grants through one or more instances of the application 100. “Lead Recipient(s)”—Generally they receive all of the funds in or for a grant, which may be distributed across more than one lead recipient, from a funder and in turn may allocate some of the funds and/or the performance requirements to sub-recipients. Sub-recipient(s)—May only receive part of the funding and performance requirements outlined by the funder. Funds received can either come from a lead recipient or another sub-recipient, but not directly from a funder. Sub-recipients only have access to the funds and performance elements allocated to them and not to any other sub-recipient that may receive funds and performance requirements from the same grant. The application 100 can manage ecosystems or environments where multiple funders, lead recipients, and sub-recipients are all related by one or more of the various relationships mentioned above. In addition, the application 100 can manage an unlimited number of sub-recipient levels, starting with, for example, multiple sub-recipients and sub-recipients of sub-recipients, and so on, within the same grant.

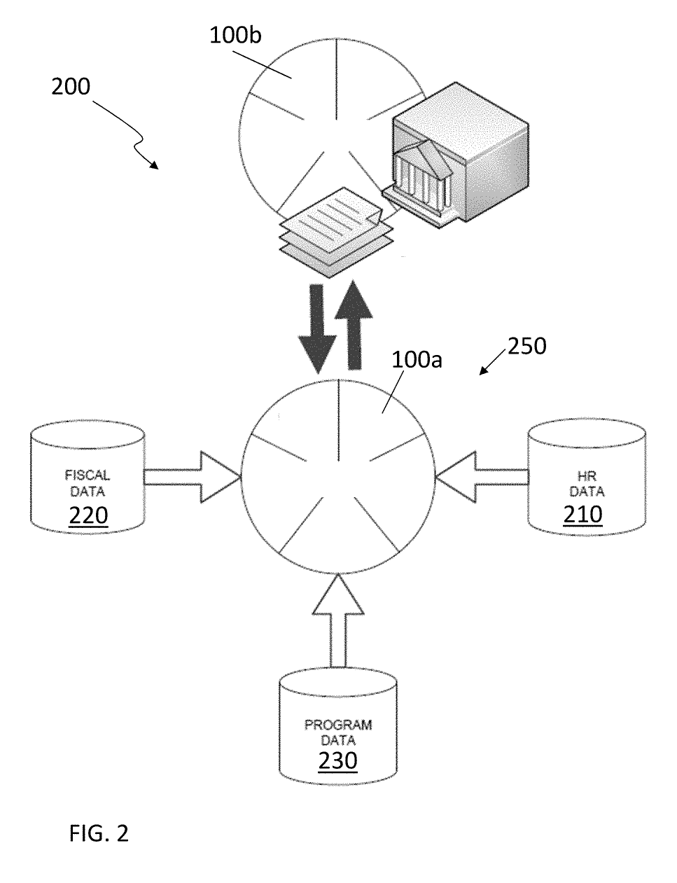

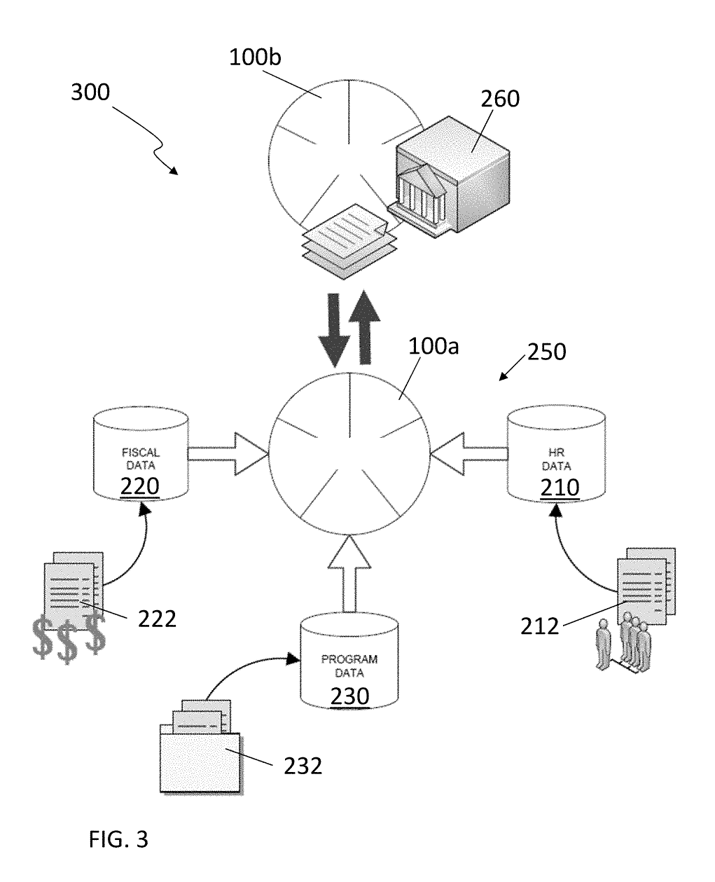

A key feature of the application 100 is the ability to consolidate and integrate data of disparate types and from disparate systems. Referring to FIG. 2, an exemplary ecosystem 200, including two instances of the application 100a, 100b, is shown, for example, with a recipient institution 250 and a funder institution 260. In this embodiment, recipient institution 250 is a lead recipient. The recipient institution 250 is shown employing the application 100a instance and the funder institution 260 is shown employing the application 100b instance. The two instances of the application 100a, 100b can cooperate with each other to exchange data, including, for example, data associated with a grant that the funder 260 has allocated to the recipient 250. As shown, the application 100a can provide an institution, for example, recipient 250, with the ability to receive (e.g., bring in, process, and/or “ingest”) information from multiple data systems, such as, for example, human resources (HR) data 210, fiscal data 220, and/or programmatic data 230. The application 100a can consolidate and integrate the disparate data from these and other sources into a standard data set and provide it to the funder 260 based on the funder's requirements, such as, for example, what data, when to send it, and how to format the data. More specifically, for example, as shown in FIG. 2, the application 100a can receive fiscal data 220, programmatic data 230, and HR data 210 in formats not dependent on any specific application or platform. (See FIG. 3 below for more examples of data types.) As shown, the application 100a can consolidate and integrate the received or imported data and attach the data to the appropriate grant items associated with the funder 260 and the recipient 250. The received data can then be used in conjunction with manually entered data to create consolidated grant reporting from the recipient 250 to the funder 260, via communications between applications 100a, 100b.

Referring now to FIG. 3, an exemplary ecosystem 300, also including two instances of the application 100a, 100b, is shown, for example, with the recipient institution 250 and the funder institution 260. In this embodiment, several types of disparate data can flow into the application 100a. For example: fiscal data 220 can include various types of fiscal data 222, including, for example, non-personnel data, budget information, receipts, general ledger/chart of accounts, any other institutionally defined data, etc.; programmatic data 230 can include various types of program data 232, including, for example, client information, case management information, time and location of services performed, any other institutionally defined data, etc.; and HR data 210 can include various types of HR data 212, including, for example, salaries, time card information, employee start date, termination, merit increase, any other institutionally defined data, etc. The ability of the application 100a to receive and process data is not dependent on the particular types of systems or applications, for example, HR, fiscal, or programmatic, that the application 100a receives the data from, but allows for receiving and processing data regardless of the types of data systems each institution, such as recipient 250, or its sub-recipients use to capture and provide their data.

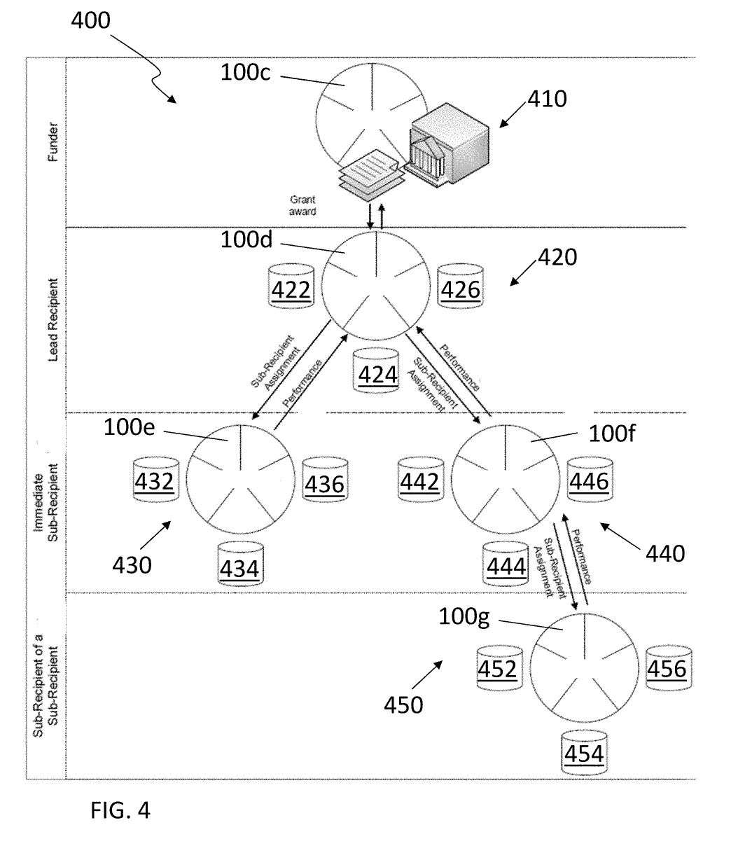

FIG. 4 depicts an exemplary grant ecosystem 400 for a single exemplary grant. The ecosystem 400 includes exemplary relationships, assignments, and performance requirements between an exemplary funder 410, exemplary lead recipient 420, and exemplary sub-recipients 430, 440, 450. Several exemplary instances of the application 100 are shown associated with each of these entities or organizations. Funder 410 is shown employing the application 100c instance, lead recipient 420 is shown employing the application 100d instance, sub-recipient 430 is shown employing the application 100e instance, sub-recipient 440 is shown employing the application 100f instance, and sub-recipient 450 is shown employing the application 100g instance. The instances of the application 100c, 100d, 100e, 100f, 100g can cooperate with each other to exchange data, including, for example, data associated with a grant that the funder 410 has allocated to the lead recipient 420, which has also allocated portions of the grant to the sub-recipients 430, 440, which has also allocated portions of the grant to another sub-recipient 450. FIG. 4 also demonstrates the various disparate sources of data associated with each instance of the application 100d, 100e, 100f, 100g, within each organization 410, 420, 430, 440, 450 of the ecosystem 400, as described in more detail below. In addition, FIG. 4 depicts the flow of information between organizations 410, 420, 430, 440, 450, including, for example, assignments and performance reporting, also described in more detail below.

In particular, as shown in FIG. 4, a single exemplary grant may be awarded from the funder 410 to the lead recipient 420 and then various sub-recipient assignments to the sub-recipients 430, 440, 450. The various instances of the application 100c, 100d, 100e, 100f, 100g allow grant activity to be tracked and reported across the multiple levels of lead recipients 420 and sub-recipients, 430, 440, 450, and ultimately to the funder 410. For example, the lead recipient 420 and sub-recipients 430, 440, 450, can each import or receive fiscal data, 422, 432, 442, 452, program data, 424, 434, 444, 454, and/or HR data 426, 436, 446, 456 from disparate systems via their respective instances of the application 100d, 100e, 100f, 100g. The applications 100d, 100e, 100f, 100g can consolidate and integrate the data into a grant tracking system of the application 100. For example, based on the data, performance metrics and tracking information can flow up from the sub-recipients 450, 440, 430 back to the lead recipient 420 and ultimately back to the funder 410 in the form of a consolidated report.

Performance data and information may be reported from lower level recipients to higher level recipients in relation to the assignments received by the lower level recipients from the higher level recipients. The reported performance data and information may be raw data from a recipient's data sources or may be a measure of performance based on the raw data. For example, sub-recipient 440 may report to lead recipient 420 regarding the performance on assignments lead recipient 420 delegated to sub-recipient 440. The data may be raw data from fiscal data 442, program data 444, and/or HR data 446, and/or performance data based on a comparison of the raw data to a delegated goal. Performance data and information may also be rolled-up to the funder 410 from multiple recipients and accessible via a fund module within the application 100c.

In another embodiment, the application 100 can aggregate performance by recipients into a measure of recipient performance based on the recipient's historical performance. This information may allow a grantor to determine which of a plurality of potential recipients may have the highest likelihood of success on a particular assignment.

Additional key features of the application 100 are the scalability of the application 100 and the interoperability of the application 100 across various organizations with a grant-based relationship. The application 100 can support numerous grants within the same ecosystem. For example, in one ecosystem, an institution could be the lead recipient, with one grant, or could be a sub-recipient for another grant, or a sub-recipient of a sub-recipient for another grant. There may be hundreds or thousands of recipient/sub-recipient combinations that can result from one or more grants entering an ecosystem.

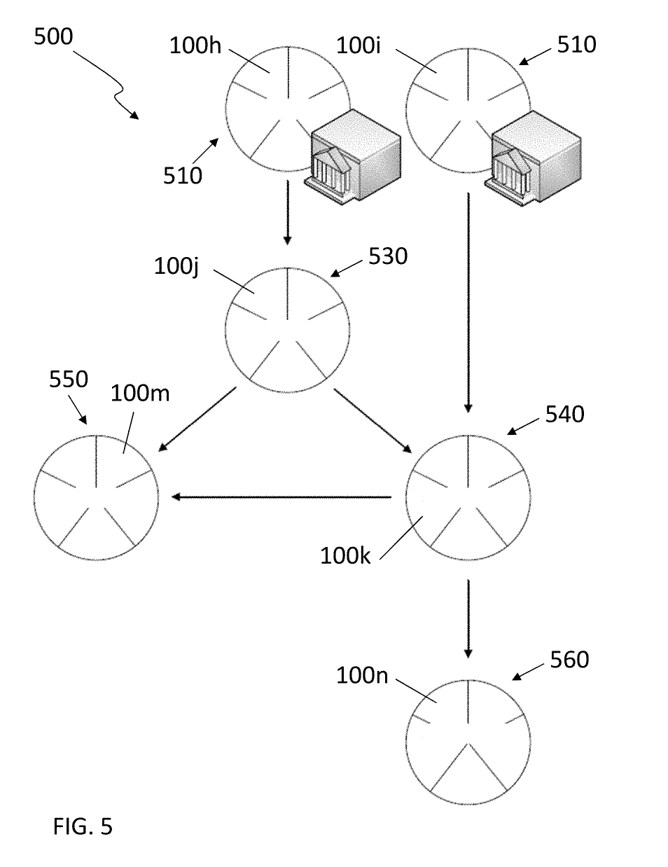

FIG. 5 depicts another exemplary grant ecosystem 500 showing multiple grants and an embodiment where an organization is involved in more than one grant. For example, two grants may be awarded from funders 510, 520 to lead recipients 530, 540. Lead recipient 530 of the first grant can allocate or award portions of the first grant to sub-recipients 540, 550. The lead recipient 540 of the second grant, who is also a sub-recipient 540 of the first grant, can allocate or award portions of the grants to sub-recipients 550, 560. In some embodiments, a sub-recipient, for example sub-recipient 550, can receive grant allocations from multiple lead recipients 530, 540 or sub-recipients 540. In other embodiments, a sub-recipient, for example sub-recipient 560, may only be allocated grants from a single organization 540. Several exemplary instances of the application 100 are shown associated with each of these entities or organizations. Funders 510, 520 are shown employing the application instances 100h, 100i, respectively, lead recipients 530, 540 are shown employing the application instances 100j, 100k, respectively, and sub-recipients 550, 560 are shown employing the application instances 100m, 100n, respectively. The instances of the application 100h, 100i, 100j, 100k, 100m, 100n, can cooperate with each other to exchange data. It should be appreciated that potential embodiments of grant ecosystems are unlimited, with unlimited entities and application 100 instances, creating a virtual “spider-web” of relationships with various assignments and performance reporting requirements via the application 100 instances that reflect the grant-based relationships and responsibilities.

A lead recipient may be ultimately responsible for the fiscal and operational performance of a grant, but the lead recipient may have to rely on other organizations, such as sub-recipients, to accomplish or achieve the grant requirements. The application 100 can allow the lead recipient to monitor the progress of the grant performance at each layer, as shown, for example, in FIGS. 4 and 5, and can provide each organization within the grant ecosystem with the ability to receive their own data from their own data systems to fulfill their specific grant obligations.

As illustrated in this application, blocks or steps of flowcharts represent logic functions, actions and/or events performed therein. It will be appreciated by one of ordinary skill in the art that electronic and software systems involve dynamic and flexible processes such that the illustrated blocks and described sequences can be performed equivalently in different sequences or in parallel. It will also be appreciated by one of ordinary skill in the art that elements embodied as software may be implemented using various programming approaches such as, for example, machine language, procedural, object-oriented, or artificial intelligence techniques. It will further be appreciated by one of ordinary skill in the art that, if desired and appropriate, some or all of the software can be embodied as part of a device's operating system.

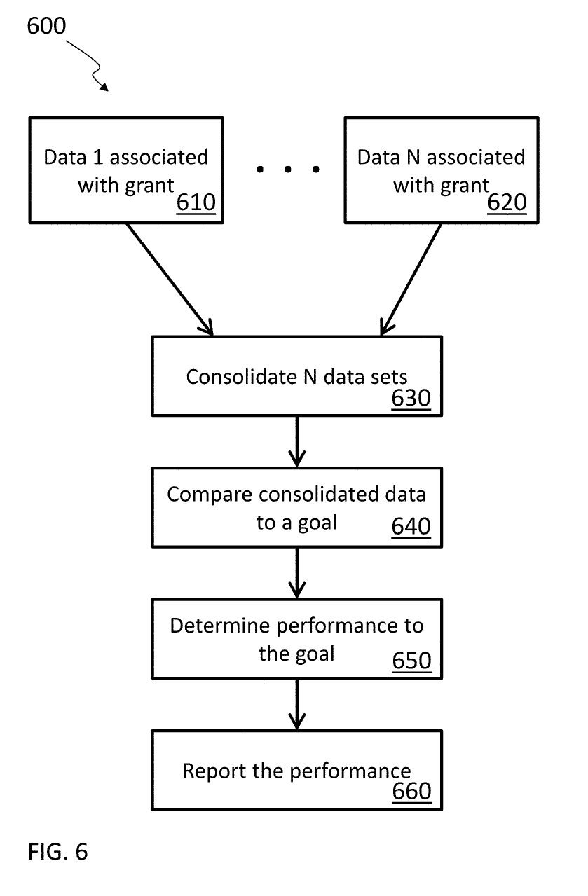

FIG. 6 is a flowchart of an exemplary process 600, which may be practiced by the application 100, for example, to consolidate and integrate disparate data and/or data from disparate data sources associated with a grant's goals, as described above. In block 610, data associated with data source 1 is captured, created, or exists. In block 620, data associated with data source N is captured, created, or exists, where N represents an indefinite number of potential data sets and/or data sources. The data from blocks 610 through 620 are then received at block 630, where the data is consolidated and/or integrated. At block 640, the consolidated data is compared to one or more goals. At block 650, the process 600 determines the performance vis-à-vis the goal. Then at block 660, the performance is reported, for example, via a roll-up with multiple other instances of the application 100, and ultimately to the funder of the grant in accordance with their reporting requirements. For example, with additional reference to the exemplary ecosystem 400 of FIG. 4, each instance of an application 100 associated with an entity, for example, a funder, a lead recipient, and/or a sub-recipient (e.g., 410, 420 430, 440), may employ the process 600 to consolidate performance data received from lower level applications 100, for example, associated with other related entities, for example, one or more lead recipients and/or one or more sub-recipients (e.g., 420, 430, 440, 450), which received funds and/or assignments from the entity.

As mentioned above, a key feature of the application 100 is the ability to consolidate and integrate data of disparate types and from disparate systems. For example, the application 100 can import standardized data sets, for example, for HR (salary/time) data and general ledger (GL) (expense) data. The nature of these datasets may dictate that they are standardized across multiple accounting and HR systems. The application 100 may accept HR and GL data from any system that produces delimited data matching the fields that are needed for the import.

The application 100 can also accept data from systems that manage programmatic data. These systems may vary widely in functionality and data definition. For example, the data captured by these systems may not be in a consistent format. As part of the data automation process, the application 100 has the capability to receive programmatic data, extract data meaningful to a grant, and consolidate the extracted data to apply an accurate measure of performance against a goal, such as, for example, a pre-defined unit-based goal or a benchmark goal. The application 100 can also support objective goals. The success of these types of goals may be managed as either “Complete” or “Not Complete,” and may be managed manually within the application 100.

For example, a unit goal may be a target number of units to complete within a specified time period within the life of a grant. A benchmark goal may be a percentage target to achieve, given a starting percentage, within a specified time period within the life of a grant. For example, the actual percentage of the benchmark per period may be calculated by dividing the available units by the number of units serviced or completed.

A primary issue with programmatic data is the variability of the data and the wide variety of data sources capturing the data. For example, programmatic data can come from case management systems (e.g., a social services field), electronic medical records/electronic health records (e.g., from health care systems), student information systems (e.g., from higher education systems), custom databases, etc. The data requirements of the grant, and more specifically a goal of the grant, may determine the type of data source required to report on performance against the goal. Given the broad range of enterprise applications collecting this data, and the customized datasets within each, it is virtually impossible to programmatically target or prepare to receive data from each of these in advance.

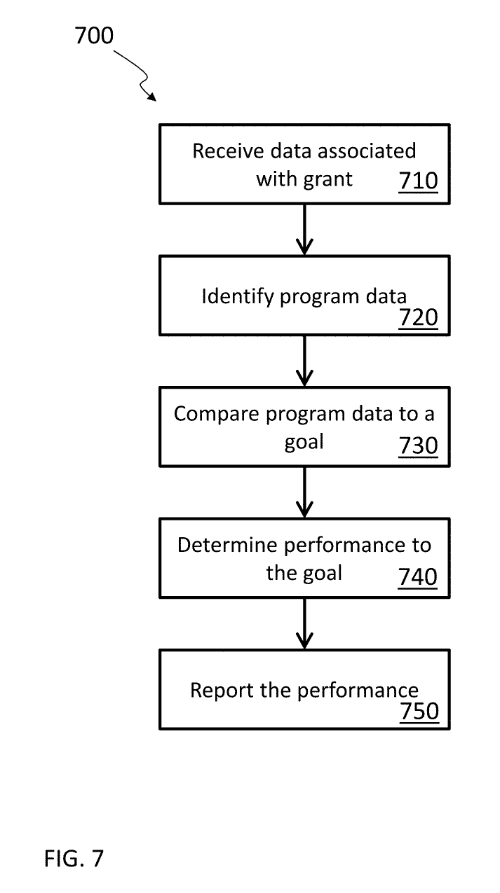

FIG. 7 is a flowchart of an exemplary process 700, which may be practiced by the application 100, for example, to handle programmatic data. In particular, the process 700 allows users, such as, for example, organizational administrators, to define the structure of the program data being received/imported along with the rules that determine how to handle each individual record that is successfully imported. At block 710, data associated with a grant is received, and at block 720, the process 700 identifies the program data within the received data. To facilitate receiving the data, for example, the data can be defined on a per column basis per table included in the data set. In addition, rules can be defined using an expression builder that allows a user to define column based conditions that the application 100 can evaluate to determine how to handle the imported record. These processes allow the application 100 to accept program data associated with a grant from any number of sources and of any type, extract meaningful performance metrics, apply those metrics to goals of the grant, and store the performance data as information associated with the grant.

For example, the application 100 can allow users to define the structure of programmatic data through a web-based interface. The user can define each data element within a record. For example, the definition may include field name, data type, data length, etc. To streamline this definition process, the application 100 can allow the user to upload a sample dataset, including, for example, multiple tables, and build a definition from that dataset. For example, the information a user can enter or review when creating a definition may be:

Record definition
Field name
Data type
Data length

In another embodiment, the user may also specify one column in the dataset as a record identifier column. This column can be used to match the uploaded record back to the original record. This column can also be used to ensure no duplicate records are submitted to the application 100.

After a data source is defined, the OA can define a data flow for that data source. For example, data flows can be manually uploaded (CSV and Excel formats) and made available or generated via a web service. The web service data flow can accept data securely as it is submitted, process the data against the rules defined below, and apply the results to the goals.

The application 100 can also allow users to build expressions using the columns defined in the data source, predefined conditional operators, grouping operators, and user supplied static values. For example, conditional operators used in expression building may include:

=(Equal)

<>(Not equal)

>(Greater than)

>=(Greater than or equal to)

<(Less than)

<=(Less than or equal to)

In (String matching within a list)

Like (String matching within a string)

Not Like (String matching not within a string)

For example, grouping operators may include:

( ) (Defines a portion of the expression to be evaluated together

AND (Specified multiple expressions that must evaluate to true)

OR (Specifies that only one of the expressions must evaluate to true)

In some embodiments, it is not necessary for the user to know to correct syntax when defining expressions. For example, the expression builder within the application 100 may be defined graphically and can automatically generate the correct syntax for the user.

At block 730, the process 700 compares the program data to a goal of the grant. This step may include utilizing defined record matching rules. The purpose of defining record matching rules against a data source is to automate the process of reporting metrics against a goal of the grant, such as, for example, a unit based goal or a benchmark goal. For example, when configuring record matching for a goal, two types of exemplary matching may be defined:
1. Qualifying records—The record matching expression is run against the entire data set to determine which records should be omitted from the measure of the goal. Defining a qualifying record expression is optional.
2. Achieved records—The record matching expression is run against the qualifying dataset (or entire dataset if qualifying is not used) to determine the records that match the achieved record expression.

At block 740, the process 700 determines the performance of the program data with respect to a goal of the grant. For example, the final step of record matching configuration may be to define how to calculate the level of achievement for a goal. For unit based goals, this measure may simply be a count of the number of records that match the achieved record expression. For benchmark goals, the user may select how to calculate the level of achievement for the goal from several exemplary options:
1. COUNT (matching records)—count of the number of records that match the achievement expression.
2. SUM (single column)—sum the values of the specified column for records that match the achievement expression.
3. SUM (multiple columns, computed)—For records that match the achievement expression create a computed column that is the result of an arithmetic operation performed on one or more columns in the record and (optionally) static values and grouping. The resulting computed column is summed with the same computed column in the other matching records.
4. AVERAGE (single column)—Average the values of the specified column for records that match the achievement expression.
5. AVERAGE (multiple columns, computed)—For records that match the achievement expression create a computed column that is the result of an arithmetic operation performed on one or more columns in the record and (optionally) static values and grouping. The resulting computed column is averaged with the same computed column in the other matching records.

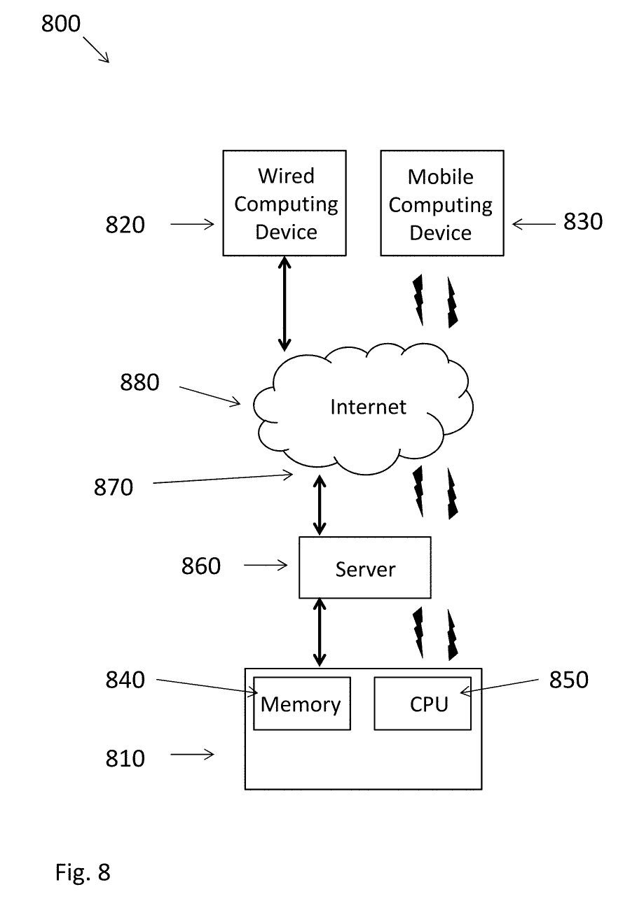

FIG. 8 includes a depiction of exemplary communication protocols and exemplary devices containing instances of the application 100, and/or providing the processes 600, 700. The devices can include the means for executing logic associated with the application 100, and/or providing the processes 600, 700, and their associated applications. The instances of the application 100 and/or its associated applications may be accessed and/or stored via a variety of computing devices 810, including, e.g., wired devices 820 (e.g., desktop computers) and mobile devices 830 (e.g., smartphones and tablets), kiosks, or any other device capable of hosting or presenting the application 100 and/or its associated applications to a user with a display and input mechanism. The application 100 and/or its associated applications may be stored in the memory 840 of a device and processed by a central processing unit (CPU) 850. The application 100 and/or its associated applications may be stored and accessed via the same device, stored remotely in a first device and accessed via a different second device, or any other combination thereof. The instances of the application 100 and/or its associated applications and/or their associated logic may be stored in local or remote memory (e.g., of a server 860), and accessible directly or via a network 870 (e.g., over the internet 880). The application 100 and/or its associated applications may also be a web-based application accessible via the internet 880. A database associated with the application 100 and/or its associated applications may be located in the same or different memory location than the application 100 and/or its associated applications. Similarly, a database associated with the application 100 and/or its associated applications may be accessed the same way or differently than the application 100 and/or its associated applications. Multiple instances of the application 100 may be coupled, cooperate, communicate, and/or exchange data with each other via any of the above protocols and devices.

### Exemplary Scenario/Embodiment #1

The first exemplary embodiment is intended to highlight and demonstrate, among other things, the ability of the application 100 to process programmatic data by using, for example, process 700. This embodiment is not intended to limit the scope of the broader features of the application 100 described above. In the following scenario, the objective is reporting the results of weight loss programs in multiple states for men and women of varying ages. The exemplary dataset being imported is:

| Participant | | | | Starting | Current |
|---|---|---|---|---|---|
| ID | Sex | Age | State | Weight | Weight |
| 1001 | M | 18 | OH | 162 | 152 |
| 1002 | M | 28 | CA | 181 | 167 |
| 1003 | F | 65 | NY | 125 | 110 |
| 1004 | M | 31 | NY | 171 | 156 |
| 1005 | F | 21 | WI | 132 | 137 |
| 1006 | M | 22 | OH | 202 | 185 |
| 1007 | M | 21 | OH | 167 | 153 |
| 1008 | F | 25 | OH | 135 | 120 |
| 1009 | F | 56 | OH | 183 | 188 |
| 1010 | F | 66 | WI | 143 | 133 |
| 1011 | M | 19 | NY | 147 | 152 |
| 1012 | M | 21 | WI | 165 | 151 |
| 1013 | M | 54 | WI | 121 | 119 |
| 1014 | F | 55 | NY | 148 | 133 |
| 1015 | M | 21 | WI | 175 | 165 |
| 1016 | F | 21 | NY | 115 | 112 |
| 1017 | M | 21 | OH | 185 | 171 |
| 1018 | F | 40 | OH | 209 | 192 |
| 1019 | F | 44 | NY | 215 | 205 |
| 1020 | F | 23 | WI | 135 | 118 |
| 1021 | F | 28 | NY | 147 | 132 |
| 1022 | M | 25 | OH | 169 | 174 |
| 1023 | F | 52 | NY | 198 | 184 |
| 1024 | M | 42 | NY | 225 | 215 |
| 1025 | F | 47 | NY | 165 | 151 |
| 1026 | F | 64 | NY | 138 | 124 |
| 1027 | F | 49 | OH | 147 | 130 |
| 1028 | F | 28 | NY | 132 | 137 |
| 1029 | F | 33 | WI | 127 | 117 |

One purpose of the exemplary grant is for an Ohio agency to oversee weight loss programs for men and women of all ages and measure the results against several goals. The data may be provided by a national organization and is not filtered by state. For the purposes of this grant, the Ohio agency is only interested in Ohio residents.

Setup

The user, such as, for example, an origination administrator (OA), creates a new data source named “Monthly Participant Weight” and defines the structure as follows:
Column 1: Participant ID, Data type is Numeric. This column is the Record Identifier column
Column 2: Sex, Data type is String and the maximum length is 1. Acceptable values are M or F
Column 3: Age, Data type is Numeric
Column 4: State, Data type is String and the maximum length is 2
Column 5: Starting Weight, Data type is Numeric
Column 6: Current Weight, Data type is Numeric

The OA specifies that the data flow for the “Monthly Participant Weight” is a manual upload.

Goal Definition

There are three defined goals for this grant. One is a unit goal and the other two are benchmark goals.

Goal 1—Provide Services for 8 Patients Per Month

The OA builds a qualifying record expression to filter the full dataset to contain only records of patients in Ohio. The expression is State=‘OH’. The OA builds an achievement record expression to match all records that have achieved the goal. In this case there is no achievement other than being in the qualifying dataset—i.e., all records count toward the goal. The OA defines the measure as a COUNT of all participants. After configuring the rule set, it is attached to the goal and processed by the application 100 after each subsequent upload of the data source.

Goal 2—Ensure That 50% of the Patients Per Month are Female

The same qualifying expression as goal 1 is used for this goal. The OA builds an achievement record expression to match all Female records in the qualified data set. The achievement record expression is Sex=‘F’. The OA defines the measure as a (COUNT of all participants in the achievement data set/COUNT of all participants in the qualified data set). After configuring the rule set, it is attached to the goal and processed by the application 100 after each subsequent upload of the data source.

Goal 3—Hit a Target Weight Loss of 5% of Body Weight for All Patients (Male and Female) Per Month

The same qualifying expression as goal 1 is used for this goal. For this goal there is no achievement expression. All patients in the qualified data set apply toward this goal. The OA defines the measure as the AVERAGE of “Starting Weight”−“Current Weight”/“Starting Weight” for all records. After configuring the rule set, it is attached to the goal and processed by the application 100 after each subsequent upload of the data source.

Goal Processing

Given the rules defined above, when a data set is uploaded into the data source “Monthly Participant Weight” the following processing occurs:

Goal 1—Provide Services for 8 Patients Per Month

The qualifying expression is evaluated by the application 100 and the dataset is filtered to only contain 9 records.

| Participant | | | | Starting | Current |
|---|---|---|---|---|---|
| ID | Sex | Age | State | Weight | Weight |
| 1001 | M | 18 | OH | 162 | 152 |
| 1006 | M | 22 | OH | 202 | 185 |
| 1007 | M | 21 | OH | 167 | 153 |
| 1008 | F | 25 | OH | 135 | 120 |
| 1009 | F | 56 | OH | 183 | 188 |
| 1017 | M | 21 | OH | 185 | 171 |
| 1018 | F | 40 | OH | 209 | 192 |
| 1022 | M | 25 | OH | 169 | 174 |
| 1027 | F | 49 | OH | 147 | 130 |

There is no achievement expression for this goal and the measure is defined as a COUNT of all participants. This count equals 9. Thus, 9 is written to this unit goal for the month.

Goal 2—Ensure That 50% of the Patients Per Month are Female (Benchmark Goal)

The qualifying expression is evaluated by the application 100 and the dataset is filtered to only contain 9 records:

| Participant | | | | Starting | Current |
|---|---|---|---|---|---|
| ID | Sex | Age | State | Weight | Weight |
| 1001 | M | 18 | OH | 162 | 152 |
| 1006 | M | 22 | OH | 202 | 185 |
| 1007 | M | 21 | OH | 167 | 153 |
| 1008 | F | 25 | OH | 135 | 120 |
| 1009 | F | 56 | OH | 183 | 188 |
| 1017 | M | 21 | OH | 185 | 171 |
| 1018 | F | 40 | OH | 209 | 192 |
| 1022 | M | 25 | OH | 169 | 174 |
| 1027 | F | 49 | OH | 147 | 130 |

The qualified data set contains 9 participants.

The achievement expression for this goal is Sex=‘F’. After processing the achievement expression, the achievement data set is:

| Participant | | | | Starting | Current |
|---|---|---|---|---|---|
| ID | Sex | Age | State | Weight | Weight |
| 1008 | F | 25 | OH | 135 | 120 |
| 1009 | F | 56 | OH | 183 | 188 |
| 1018 | F | 40 | OH | 209 | 192 |
| 1027 | F | 49 | OH | 147 | 130 |

The achievement data set contains 4 participants.

The measure of this goal is defined as (COUNT of all participants in the achievement data set/COUNT of all participants in the qualified data set). This evaluates to 4/9=44%. 44% is written to the goal.

Goal 3—Hit a Target Weight Loss of 5% of Body Weight for All Patients (Male and Female) Per Month

The qualifying expression is evaluated by the application 100 and the dataset is filtered to only contain 9 records:

| Participant | | | | Starting | Current | Weight Loss |
|---|---|---|---|---|---|---|
| ID | Sex | Age | State | Weight | Weight | (Computed) |
| 1001 | M | 18 | OH | 162 | 152 | 10 |
| 1006 | M | 22 | OH | 202 | 185 | 17 |
| 1007 | M | 21 | OH | 167 | 153 | 14 |
| 1008 | F | 25 | OH | 135 | 120 | 15 |
| 1009 | F | 56 | OH | 183 | 188 | −5 |
| 1017 | M | 21 | OH | 185 | 171 | 14 |
| 1018 | F | 40 | OH | 209 | 192 | 17 |
| 1022 | M | 25 | OH | 169 | 174 | −5 |
| 1027 | F | 49 | OH | 147 | 130 | 17 |

The qualified data set contains 9 participants.

There is no achievement expression for this goal—all qualifying records apply.

The measure of this goal is defined as the AVERAGE of “Starting Weight”−“Current Weight”/“Starting Weight” for all records. “Starting Weight”−“Current Weight” is computed by the application 100 as shown in the last column above labeled “Weight Loss (Computed)”. The AVERAGE of “Weight Loss (Computed)”/“Starting Weight” for all records is 6.2%. 6.2% is written to the goal.

Goal Post-Processing

After processing the rule sets for each goal the application 100 saves the qualifying dataset to the goal for historical data. The dataset may then be accessed for reporting performance, such as, for example, as part of a performance roll-up for the associated grant in accordance with the funder's requirements.

### Exemplary Scenario/Embodiment #2

The second exemplary embodiment is intended to highlight and demonstrate, among other things, the scalability of the application 100 and the ability of the application 100 to process a data and from various data sources, including the handling of programmatic data. This embodiment is not intended to limit the scope of the broader features of the application 100 described above. Although the following details are in an outline form, it should be clear to one skilled in the art based on the above description. In the following exemplary description, many of the steps may be omitted or handled differently than described. For example, references to program manager activities may be automated by the application 100.

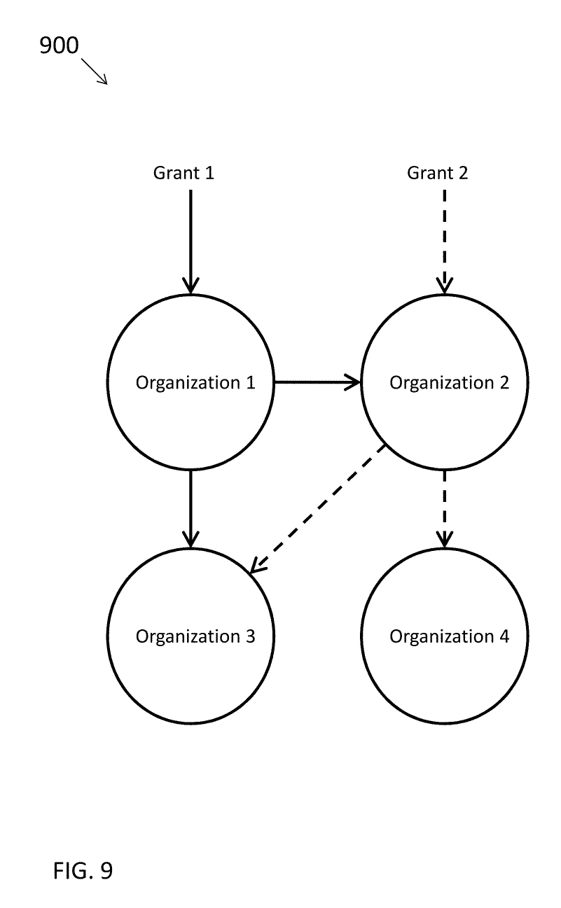

Entities/Grants (See Ecosystem 900 of FIG. 9.)

Grant 1: Federal Neighborhood Revitalization Program
Award Amount: $200,000,000
Performance Goal: Stabilize communities that have suffered from foreclosures and abandonment
Grant Duration: Three years
Number of Lead Organizations: 5
Number of Sub-recipients: 56
(Reference: NYC HUD Grant)

Grant 2: Federal Resource Recovery Program
Award Amount: $20,000,000
Performance Goal: Support infrastructure projects to ensure clean and safe drinking water
Grant Duration: Two years
Number of Lead Organizations: 3
Number of Sub-recipients: 17
(Reference: EPA Water Quality Grant, ARRA)

Organization 1—Large public organization
Received Grant 1>lead to Organizations 2 and 3 (shown in FIG. 8 as solid line)
   Total Award=$40,000,000 (G1)
Staff—Staff 1=Grant Manager—0% of time to grants
   Staff 2=Program Manager—50% of time to Grant 1
   Staff 3=Staff Member—100% of time to Grant 1
Program Goal=Stabilize communities impacted by foreclosures and abandonment

Organization 2—Large public organization
Received Grant 2>lead to Organizations 3 and 4 (shown in FIG. 8 as dashed line)
Sub-recipient to Organization 1>Grant 1
   Total Award =$17,000,000 ($10,000,000 Grant 1+$7,000,000 Grant 2)
Staff—Staff 1=Grant Manager—0% of time to grants
   Staff 2=Program Manager—50% of time to Grant 2, 25% to Grant 1
   Staff 3=Staff Member—40% of time to Grant 2, 20% to Grant 1
Program Goals=Grant 1=Identify and provide stabilization for three local communities
   Grant 2=Identify and manage clean water infrastructure improvements

Organization 3—Public organization
Sub-recipient to Organization 1>Grant 1
Sub-recipient to Organization 2>Grant 2
   Total Award=$7,000,000 ($5,000,000 Grant 1 via Org 1+$2,000,000 Grant 2 via Org 2)
Staff—Staff 1=Grant Manager—0% of time to grants
   Staff 2=Program Manager—20% of time to Grant 1, 10% to Grant 2
   Staff 3=Staff Member—10% of time to Grant 1
Program Goals=Grant 1=Identify and provide stabilization for one local community
   Grant 2=Identify and manage clean water infrastructure improvements

Organization 4—Public service organization
Sub-recipient to Organization 2>Grant 2
   Total Award=2,000,000 Grant 2 via Org 2
Staff—Staff 1=Grant Manager—20% of time to various grants as overhead or indirect costs
   Staff 2=Program Manager—10% of time to Grant 2
   Staff 3=Staff Member—30% of time to Grant 2
Performance Goal=Grant 2=Identify and manage clean water infrastructure improvements

Narrative Grant 1: Federal Neighborhood Revitalization Program

Funder for Grant 1—Federal Neighborhood Revitalization Program awards $40,000,000 of the total $200,000,000 of the grant to Organization 1 as the lead recipient and fiscal agent in a consortium composed of 10 sub-recipients. The case study below reviews the flow of information between and among the funder, Organization 1, and two of the ten sub-recipients Organizations 2 and 3.

### A. Application 100 Set-Up.

1. Import or enter grantor information
2. Create administrative lists
   a. Grant Category—grantor's defined budget categories
   b. Subject and Department lists
3. Import staff data—formatted for universal upload into the application 100
   a. Salary
   b. Unique employee reference number
   c. Email addresses, job title, start date, etc.
4. Import accounting data—formatted for universal upload into the application 100
   a. Numerical accounting codes including category and line item

### B. Grant Record Creation.

Organization 1 creates a grant record in the application 100 which includes:
1. Grant detail
   a. Grant title, proposal information, awarded date, awarded amount, tracking intervals, other relevant detail
2. Performance Plan
   a. Agreements. Identify and establish formal agreements with 11 communities which have been impacted by foreclosures and abandonment (11 of 11)
   b. Mediation. Provide foreclosure mediation to all impacted home owners and lenders in each identified community to ensure a mutually agreeable solution to both parties while minimizing risk to the local community (100%).
   c. Removal. Identify and remove all abandoned homes in each community (100%)
3. Budget Plan
   Total=$40,000,000
      Personnel $18,000,000
      Fringe Benefits $1,260,000
      Travel $50,000
      Equipment $100,000
      Supplies $50,000
      Contractual $10,000,000
      Construction $10,000,000
      Other $120,000
      Indirect Charges $420,000
4. Responsible personnel at Organization 1 and their allocation to Grant 1 Federal Neighborhood Revitalization Program
   a. Program Manager $60,000 annual salary 50% of time to Grant 1
      i. Responsible for reporting, performance, budget, and sub-recipient performance
   b. Staff Member $50,000 annual salary 100% of time to Grant 1
      i. Responsible for day-to-day operations and support of Grant 1
5. Sub-recipient Allocation
   a. Organization 2
      i. Performance Goals
         (1) Agreements. Identify and establish formal agreements with 3 communities which have been impacted by foreclosures and abandonment
         (2) Mediation. Provide foreclosure mediation to all impacted home owners and lenders in each of the three identified communities to ensure a mutually agreeable solution to both parties while minimizing risk to the local communities
         (3) Removal. Identify and remove all abandoned homes in each community
      ii. Budget Plan
         Total=$10,000,000
         Personnel $4,500,000
         Fringe Benefits $315,000
         Travel $12,500
         Equipment $25,000
         Supplies $12,500
         Contractual $2,500,000
         Construction $2,500,000
         Other $30,000
         Indirect Charges $105,000
   b. Organization 3
      i. Performance Goals
         (1) Agreements. Identify and establish a formal agreement with 1 community which has been impacted by foreclosures and abandonment
         (2) Mediation. Provide foreclosure mediation to all impacted home owners and lenders in the community to ensure a mutually agreeable solution to both parties while minimizing risk to the local communities
         (3) Removal. Identify and remove all abandoned homes in the community
      ii. Budget Plan
         Total=$5,000,000
         Personnel $2,250,000
         Fringe Benefits $157,500
         Travel $6,250
         Equipment $12,500
         Supplies $6,250
         Contractual $1,250,000
         Construction $1,250,000
         Other $15,000
         Indirect Charges $52,500

### C. Sub-Recipient Review and Set-Up.

Organizations 2 and 3 are able to review their Performance and Budget Plan as allocated by Organization 1. Both organizations follow these steps to set-up their the application 100 account:
1. Import or enter grantor information
2. Create administrative lists
   a. Grant Category—grantor's defined budget categories
   b. Subject and Department lists
3. Import staff data—formatted for universal upload into the application 100
   a. Salary
   b. Unique employee reference number
   c. Email addresses, job title, start date, etc.
4. Import accounting data—formatted for universal upload into the application 100
   a. Numerical accounting codes including category and line item
5. Within the grant record which has been assigned to them both organizations take the following steps:
   a. Allocate their staff to the grant
      i. Employee reference number provides the link to the actual data which will be imported
   b. Internal accounting codes are linked to the grantor's categories of spend, category and line items provide the link to the actual data which will be imported
   c. Assign this grant to their internal departments or programs
   d. Assign internal subjects to the grant record

### D. Data Flow.

Organization 1 sets the reporting tracking interval to quarterly to comply with the grantor's reporting time table. The application 100 automatically creates quarterly tracking forms for all sub-recipients. These tracking forms calculate the planned performance and budget goals for each tracking interval. Organization 1 spreads the performance and budget goals either evenly or differentially over the time period of the grant; this decision is based on requests of sub-recipients and constraints of the grant timeline. Organization 1 requires sub-recipients to import actual salary and accounting data from their human resources and accounting systems. This ensures that auditable data is available in the application 100 at all times.
1. Tracking Forms.
There are two types of tracking forms which all sub-recipients are required to complete.
   a. Performance Tracking
      i. Data fields include (in part)
         (1) Date, service, goal measurement (discrete units, percentage, complete/not-complete)
         (2) Multiple line items
         (3) Notes for narrative detail
         (4) Document uploads for required supporting documentation (contracts, case management detail, etc.)
      ii. Calculations within this form include
         (1) Total of all line items
         (2) Budgeted units for tracking interval
         (3) Actual units for tracking interval
         (4) Period to date
         (5) Grant to date
   b. Reimbursement Tracking
      i. Data fields include (in part)
         (1) Reference number, date, vendor, amount
         (2) Multiple line items
         (3) Notes for narrative detail
         (4) Document uploads for required supporting documentation (invoices, receipts, purchase orders, etc.)
      ii. Calculations within this form include
         (1) Total of all line items
         (2) Budgeted units for tracking interval
         (3) Actual units for tracking interval
         (4) Period to date
         (5) Grant to date
2. Data Import.
Organization 2 completes the following actions prior to the tracking form due date.
   a. Reviews performance and reimbursement goals assigned by Organization 1, ensures Organization 2's staff and accounting data is accurate and has been imported into the application 100 for the required tracking interval.
   b. Completes the performance tracking form for quarter one of this grant, submits the following data to Organization 1 for approval
      i. Agreements. Has identified and established 1 formal agreement with a community which has been impacted by foreclosures and abandonment. A copy of the signed MOU is attached to this data entry form for review by the lead. (1/3 for the grant period, 1/1 for this tracking interval).
      ii. Mediation. Provided foreclosure mediation to 25% of the impacted home owners and 25% of the lenders in the identified community to ensure a mutually agreeable solution to both parties while minimizing risk to the local communities. Supporting documentation submitted with this tracking form includes detailed case notes on each owner and lender.
      iii. Removal. Identified 100 homes in need of removal, home removal has not yet begun. Attached MOU includes detailed descriptions of the abandoned homes in community 1 which will be removed. (0%/100% for grant period, 0%/100% for tracking interval—homes identified, not yet removed).
   c. Completes the personnel section of the reimbursement tracking form for quarter one of this grant, submits reimbursement data to Organization 1 for approval. The following personnel assignments have been made at Organization 2—Program Manager earns a $40,000 annual salary, 25% of which is allocated to Grant 1; and Staff Member earns a $30,000 annual salary, 20% of which has been allocated to Grant 1. Organization 2 uploads salary actual data from the human resources system into The application 100 this data includes actual salary paid and actual hours worked for the given time period. The application 100 uses the unique employee reference number to tie this data to the personnel assignment and allocation percentage made to this grant. The actual salary data which are automatically loaded into the tracking form include
      i. Program manager's actual allocated salary for the tracking interval $2500.00 (the application 100 has calculated this amount based on the personnel assignments described above).
      ii. Staff member's actual allocated salary for this tracking interval $1500.00 (the application 100 has calculated this amount based on the personnel assignments described above).
      iii. For each personnel item above the application 100 calculates and displays the budgeted amounts for this tracking interval, the period to date and grant year to date amounts. Once entered and calculated these data are also available for Organization 1 to run status and projection reports.
   d. Completes the remaining sections of the reimbursement tracking from. The grantor's categories of spend have been entered into the application 100 and matched to Organization 2's accounting codes. The actual amounts spend in each of the relevant accounting codes have been uploaded into the application 100 from the organizations accounting system. The actual spend data which appears in the tracking form includes:
      i. Grantor Category=Travel
         (1) Organization 2 line item=In-county mileage, actual amount=$500 Notation indicates the dates and purpose of the travel, scanned copies of the exact mileage for each trip is uploaded as supporting documentation for this item.
      ii. Grantor Category=Equipment
         (1) Organization 2 line item=Computer hardware, actual amount=$3000 Notation includes a detailed description of the computer hardware purchased; invoices are uploaded to document these purchases.
      iii. For each item above the application 100 calculates and displays the budgeted amounts for this tracking interval, the period to date and grant year to date amounts. The application 100 notes that the Travel category is below the budgeted amount, and that the Equipment category is over the budgeted amount for this tracking interval. Once entered and calculated these data are also available for Organization 1 to run status and projection reports.
Organization 3 completes the same actions completed by Organization 2 which are outlined above. The following personnel assignments have been made at Organization 3—Program Manager earns a $40,000 annual salary, 20% of which is allocated to Grant 1; and Staff Member earns a $25,000 annual salary, 10% of which has been allocated to Grant 1. The actual data entered into the application 100 by Organization 3 is as follows.
   a. Performance
      i. Agreements. Community assessment has taken place and the community to be targeted has been identified, the formal MOU has not yet been finalized. (0/1 for grant period, 0/0 for this tracking interval).
      ii. Mediation. Identification of homeowners and lenders will commence when MOU is finalized. (0%/100% for grant period, 0%/0% for this tracking interval).
      iii. Removal. The number and condition of abandoned homes is this community is larger than expected, the cost and duration of this goal will be much higher than expected. (0%/100% for grant period, 0%/100% for tracking interval—homes identified, not yet removed).
   b. Personnel
      i. Program manager's actual allocated salary for this tracking interval is $2000.00
      ii. Staff members' actual allocated salary for this tracking interval is $625.00
   c. Other Line Items
      i. Grantor Category=Contractual
         (1) Organization 2 Category=Construction Contracts, Actual amount=$200,000
      ii. Grantor Category=Construction
         (1) Organization 2 Category=Construction Contracts, Actual amount=$200,000
3. Data Review, Approval and Reporting
   a. Tracking Forms
      i. Program Manager at Organization 1 reviews the performance and reimbursement tracking forms and all supporting documentation which have been submitted by each sub-recipient. The tracking forms present a quick visual status indicator as the amounts which are under goal appear in blue font and in parenthesis; amounts over goals are in red font.
         (1) Program manager reviews the performance data submitted by Sub-recipient Organization 2 and Organization 3. Performance goal progress is approved for both organizations as they are both tracking to their assigned goals for the tracking interval.
         (2) Program manager reviews the reimbursement data submitted by sub-recipient Organization 2. Several reimbursement items are significantly higher than the allocated amounts for this tracking interval. Resubmission is required from Organization 2, and additional documentation is required.
         (3) Program manager reviews the reimbursement data submitted by sub-recipient Organization 3. Contractual expenditures are significantly higher for this tracking interval than planned. Resubmission is required from Organization 2, and additional documentation is required.
   b. Reporting
      i. Program manager at Organization 1 then submits the following data to the funder for the quarterly reports: all of this data is generated automatically based on the data which has been submitted by sub-recipients and approved by the lead organization.
         (1) Spend down status of the grant by grantor's spend category
         (2) Performance and reimbursement status by sub-recipient
         (3) Performance to reimbursement percentage
         (4) Budget narratives explaining the intended purpose of each budget category and any changes to its intended purpose.

Narrative Grant 2: Federal Resource Recovery Program

Funder for Grant 2 Federal Resource Recovery Program awards $7,000,000 of the total $20,000,000 of this grant to Organization 2 as the lead recipient and fiscal agent in a consortium composed of 5 sub-recipients. The case study below reviews the flow of information between and among the funder, Organization 2, and two of the five sub-recipients Organizations 3 and 4.

### A. Grant Record Creation.

Organization 2 creates a grant record in the application 100 which includes:
1. Grant detail
   a. Grant title, proposal information, awarded date, awarded amount, tracking intervals, other relevant detail
2. Performance Plan
   a. Identify. Evaluate water infrastructure projects; select and implement five projects with the highest impact on the provision of clean and safe drinking water.
   b. Manage. Implement five water infrastructure projects from evaluation through completion.
3. Budget Plan
   Total $7,000,000
      Personnel $150,000
      Fringe Benefits $50,000
      Equipment $1,000,000
      Supplies $300,000
      Contractual $1,000,000
      Construction $4,000,000
      Other $250,000
      Indirect Charges $250,000
4. Responsible personnel at Organization 2 and their allocation to Grant 2 Federal Resource Recovery Program
   a. Program Manager $40,000 annual salary 50% of time to Grant 2
   b. Staff Member $30,000 annual salary 40% of time to Grant 2
5. Sub-recipient Allocation
   a. Organization 3
      i. Performance Goals
         (1) Identify. Evaluate water infrastructure projects; select and implement one project with the highest impact on the provision of clean and safe drinking water.
         (2) Manage. Implement one water infrastructure project from evaluation through completion.
      ii. Budget Plan
         Total $2,000,000
         Personnel $82,000
         Fringe Benefits $14,000
         Equipment $280,000
         Supplies $84,000
         Contractual $280,000
         Construction $1,120,000
         Other $70,000
         Indirect Charges $70,000
   b. Organization 4
      i. Performance Goals
         (1) Identify. Evaluate water infrastructure projects; select and implement one project with the highest impact on the provision of clean and safe drinking water.
         (2) Manage. Implement one water infrastructure project from evaluation through completion.
      ii. Budget Plan
         Total $2,000,000
         Personnel $82,000
         Fringe Benefits $14,000
         Equipment $280,000
         Supplies $84,000
         Contractual $280,000
         Construction $1,120,000
         Other $70,000
         Indirect Charges $70,000
Indirect Charges
   B. Sub-Recipient Review and Set-Up.
Organizations 3 and 4 are able to review their Performance and Budget Plan as allocated by Organization 2. Both organizations follow these steps to set-up their application 100 account:
1. Import or enter grantor information
2. Create administrative lists
   a. Grant Category—grantor's defined budget categories
   b. Subject and Department lists
3. Import staff data—formatted for universal upload into the application 100
   a. Salary
   b. Unique employee reference number c. Email addresses, job title, start date, etc.
4. Import accounting data—formatted for universal upload into the application 100
   a. Numerical accounting codes including category and line item
5. Within the grant record which has been assigned to them both organizations take the following steps:
   a. Allocate their staff to the grant
      i. Employee reference number provides the link to the actual data which will be imported
   b. Internal accounting codes are linked to the grantor's categories of spend, category and line items provide the link to the actual data which will be imported
c. Assign this grant to their internal departments or programs
d. Assign internal subjects to the grant record

### C. Data Flow.

Organization 2 sets the reporting tracking interval to quarterly to comply with the grantor's reporting time table. The application 100 automatically creates quarterly tracking forms for all sub-recipients. These tracking forms calculate the planned performance and budget goals for each tracking interval. Organization 2 spreads the performance and budget goals either evenly or differentially over the time period of the grant; this decision is based on requests of sub-recipients and constraints of the grant timeline. Organization 2 requires sub-recipients to import actual salary and accounting data from their human resources and accounting systems. This ensures that auditable data is available in the application 100 at all times.
1. Tracking Forms.
There are two types of tracking forms which all sub-recipients are required to complete.
   a. Performance Tracking
      i. Data fields include (in part)
         (1) Date, service, goal measurement (discrete units, percentage, complete/not-complete)
         (2) Multiple line items
         (3) Notes for narrative detail
         (4) Document uploads for required supporting documentation (contracts, case management detail, etc.)
      ii. Calculations within this form include
         (1) Total of all line items
         (2) Budgeted units for tracking interval
         (3) Actual units for tracking interval
         (4) Period to date
         (5) Grant to date
   b. Reimbursement Tracking
      i. Data fields include (in part)
         (1) Reference number, date, vendor, amount
         (2) Multiple line items
         (3) Notes for narrative detail
         (4) Document uploads for required supporting documentation (invoices, receipts, purchase orders, etc.)
      ii. Calculations within this form include
         (1) Total of all line items
         (2) Budgeted units for tracking interval
         (3) Actual units for tracking interval
         (4) Period to date
         (5) Grant to date
2. Data Import.
Organization 3 completes the following actions prior to the tracking form due date.
   a. Reviews performance and reimbursement goals assigned by Organization 2, ensures Organization 3's staff and accounting data is accurate and has been imported into the application 100 for the required tracking interval.
   b. Completes the performance tracking form for quarter one of this grant, submits the following data to Organization 2 for approval
      i. Identify. Evaluation of projects will be conducted internally. Project list has been requested, selection not yet complete (0/1).
      ii. Manage. No progress to date (0/1).
   c. Completes the personnel section of the reimbursement tracking form for quarter one of this grant, submits reimbursement data to Organization 2 for approval. The following personnel assignments have been made at Organization 3—Staff Member earns a $30,000 annual salary, 10% of which has been allocated to Grant 2. Organization 3 uploads salary actual data from the human resources system into the application 100 this data includes actual salary paid and actual hours worked for the given time period. The application 100 uses the unique employee reference number to tie this data to the personnel assignment and allocation percentage made to this grant. The actual salary data which are automatically loaded into the tracking form include:
      i. Staff member's actual allocated salary for this tracking interval $750.00. Supporting documentation is submitted for this expense, Staff member is conducting the project evaluation, Staff member's time is unevenly allocated in the first two quarters of this grant.
      ii. For the personnel item above the application 100 calculates and displays the budgeted amounts for this tracking interval, the period to date and grant year to date amounts. Once entered and calculated these data are also available for Organization 2 to run status and projection reports.
   d. Completes the remaining sections of the reimbursement tracking from. The grantor's categories of spend have been entered into the application 100 and matched to Organization 3s accounting codes. The actual amounts spent in each of the relevant accounting codes have been uploaded into the application 100 from the organizations accounting system. The actual spend data which appears in the tracking form includes:
      i. Grantor Category=Contractual
         (1) Organization 3 Category=Sub-contractor=$10,000
      ii. For each item above the application 100 calculates and displays the budgeted amounts for this tracking interval, the period to date and grant year to date amounts. The application 100 notes that the Travel category is below the budgeted amount, and that the Equipment category is over the budgeted amount for this tracking interval. Once entered and calculated these data are also available for Organization 2 to run status and projection reports.

Organization 4 completes the same actions completed by Organization 3 which are outlined above. The following personnel assignments have been made at Organization 4—Program Manager earns a $30,000 annual salary, 10% of which is allocated to Grant 2; and Staff Member earns a $25,000 annual salary, 30% of which has been allocated to Grant 2. The actual data entered into the application 100 by Organization 4 is as follows:
a. Performance
   i. Identify. Project evaluator contract complete, evaluation to commence. Projects not yet identified (0/1).
   ii. Manage. Projects not yet identified. (0/1)
b. Personnel
   i. Program manager's actual allocated salary for this tracking interval is $750.00
   ii. Staff members' actual allocated salary for this tracking interval is $1875.00
c. Other Line Items
   i. Grantor Category=Equipment
      (1) Organization 4 Category=Heavy Equipment Lease, Actual amount=$200,000
   ii. Grantor Category=Contractual
      (1) Organization 2 Category=Professional Consultant Contracts, Actual amount=$20,000
3. Data Review, Approval and Reporting
   a. Tracking Forms
      i. Program Manager at Organization 2 reviews the performance and reimbursement tracking forms and all supporting documentation which have been submitted by each sub-recipient. The tracking forms present a quick visual status indicator as the amounts which are under goal appear in blue font and in parenthesis; amounts over goals are in red font.
         (1) Program manager reviews the performance data submitted by Sub-recipient Organization 3 and Organization 4. Performance goal progress is approved for both organizations. However, program manager at Organization 2 schedules a consortium meeting as it appears the project is off to a slower than expected start.
         (2) Program manager reviews the reimbursement data submitted by sub-recipient Organization 3. Personnel reimbursement items are significantly higher than the allocated amounts for this tracking interval. Resubmission is required from Organization 3, and additional documentation is required.
         (3) Program manager reviews and approves the reimbursement data submitted by sub-recipient Organization 3.
   b. Reporting
      i. Program manager at Organization 2 then submits the following data to the funder for the quarterly reports. All of this data is generated automatically based on the data which has been submitted by sub-recipients and approved by the lead organization.
         (1) Spend down status of the grant by grantor's spend category
         (2) Performance and reimbursement status by sub-recipient
         (3) Performance to reimbursement percentage
         (4) Budget narratives explaining the intended purpose of each budget category and any changes to its intended purpose.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departing from the spirit or scope of the applicant's general inventive concept.

1-41. (canceled)

42. A system for managing grants comprising:
a first set of data having an achievement expression associated with the at least one grant and at least one of fiscal data associated with the at least one grant, human resource data associated with the at least one grant, and program data associated with the at least one grant;
a second set of data having at least one of fiscal data associated with the at least one grant, human resource data associated with the at least one grant, and program data associated with the at least one grant and wherein the second set of data is in a format disparate from the first set of data;
a database wherein data of the first and second sets of data are compared to the achievement expression of the at least one grant to determine a performance associated with the achievement expression, a result being stored in the database; and
a report of the performance associated with the achievement expression based on the first and second sets of data.

43. The system of claim 42, wherein the achievement expression is a unit goal.

44. The system of claim 42, wherein the achievement expression a benchmark goal.

45. The system of claim 42, wherein the performance is determined by using one of a count of data records satisfying the achievement expression, a sum of data records of a data column matching the achievement expression, a sum of data records of a computed column resulting from an arithmetic operation performed on a plurality of columns, an average of a data column, and an average of data records of a computed column resulting from an arithmetic operation performed on a plurality of columns.

46. The system of claim 42, further comprising a set of record definitions that facilitate comparison between disparate data of the first and second data sets.

47. The system of claim 46, wherein the set of record definitions comprises at least one of a field name, a data type, and a data length.

48. The system of claim 1, wherein the result is one of a qualifying record and an achieved record.

49. A method for managing grants comprising:
providing a first set of data having an achievement expression associated with the at least one grant and at least one of fiscal data associated with the at least one grant, human resource data associated with the at least one grant, and program data associated with the at least one grant;
providing a second set of data having at least one of fiscal data associated with the at least one grant, human resource data associated with the at least one grant, and program data associated with the at least one grant and wherein the second set of data is in a format disparate from the first set of data;
providing a set of rules for comparing the first and second sets of data to determine a performance associated with the achievement expression;
applying the set of rules to the first and second sets to produce a performance result based on the first and second sets of data; and
generating a report of the performance result.

50. The method of claim 49, wherein the achievement expression is a unit goal.

51. The method of claim 49, wherein the achievement expression a benchmark goal.

52. The method of claim 49, wherein the set of rules comprises one of a count of data records satisfying the achievement expression, a sum of data records of a data column matching the achievement expression, a sum of data records of a computed column resulting from an arithmetic operation performed on a plurality of columns, an average of a data column, and an average of data records of a computed column resulting from an arithmetic operation performed on a plurality of columns.

53. The method of claim 49, further comprising applying a set of record definitions to the first and second data sets to facilitate comparison between disparate data of the first and second data sets.

54. The method of claim 53, wherein the set of record definitions comprises at least one of a field name, a data type, and a data length.

55. The method of claim 49, wherein the result is one of a qualifying record and an achieved record.
